(19) United States
(12) Patent Application Publication
(10) Pub. No.: US 2005/0253291 A1
(43) Pub. Date: Nov. 17, 2005

(54) Process and apparatus for molding optical lenses

(76) Inventor: Harald Volkenandt, Aalen (DE)

Correspondence Address: HARNESS, DICKEY & PIERCE, P.L.C., P.O. BOX 828, BLOOMFIELD HILLS, MI, 48303, US

(21) Appl. No.: 11/051,804

(22) Filed: Feb. 4, 2005

Related U.S. Application Data
(63) Continuation of application No. PCT/EP03/07306, filed on Jul. 8, 2003.

(30) Foreign Application Priority Data
Aug. 7, 2002 (DE) 102 36 714.0

(51) Int. Cl. B29D 11/00

(52) U.S. Cl. 264/1.36; 264/2.5; 425/406; 425/808

(57) ABSTRACT

A process and an apparatus are used for molding optical lenses from a thermosettable plastic material. Two molding shells having surfaces of a predetermined shape are arranged at a distance relative to one another and are sealed at their periphery. The plastic material is brought into the gap enclosed by the surfaces between the molding shells. At least one of the surfaces is deformed from an initial shape into the predetermined shape immediately prior to the bringing in of the plastic material and depending on predetermined data.

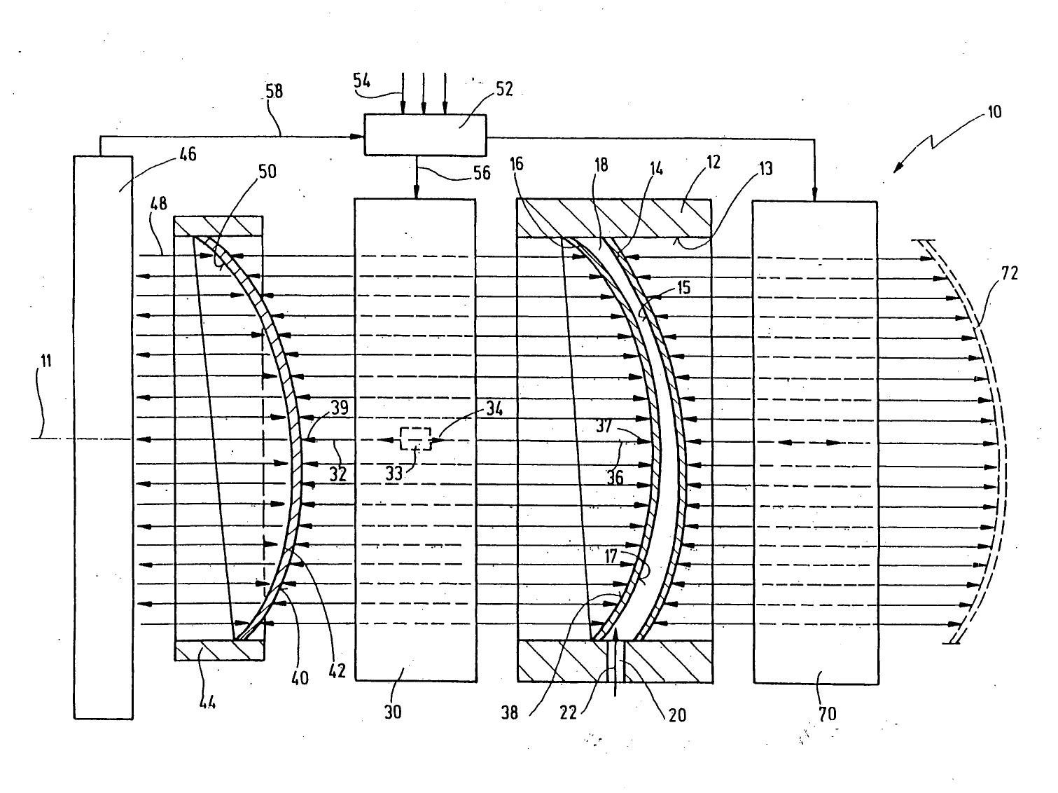

### CROSS-REFERENCE TO RELATED APPLICATIONS

This application is a continuation of international patent application PCT/EP2003/007306, filed Jul. 8, 2003 and designating the U.S., which was not published under PCT Article 21(2) in English, and claims priority of German patent application DE 102 36 714.0, filed Aug. 07, 2002, which is incorporated herein by reference.

### FIELD OF THE INVENTION

The present invention is related to the field of making lenses from plastic material.

More specifically, the invention is related to a process for molding optical lenses from a thermosettable plastic material, wherein two molding shells having surfaces of a predetermined shape are arranged at a distance relative to one another and are sealed at their periphery, the plastic material being brought into the gap enclosed by the surfaces between the molding shells.

The invention is, further, related to an apparatus for molding optical lenses from a thermosettable plastic material, comprising two molding shells arranged at a distance relative to one another, the molding shells having surfaces of a predetermined shape, and a sealing at the periphery of the molding shells, and means for bringing the plastic material into the gap enclosed by the surfaces between the molding shells.

### BACKGROUND OF THE INVENTION

A process and an apparatus of the afore-mentioned kind have been known, for example from WO 01/32407 A1.

It has become more and more customary to use spectacle lenses from plastic material for spectacles. Such plastic material spectacle lenses are conventionally manufactured by molding and subsequent thermosetting of an appropriate plastic material. In this context it is known to first manufacture blanks by molding, wherein one of the two lens surfaces, most commonly the front surface, is already molded to its final shape. The other surface, most commonly the rear surface (also referred to as the “prescription surface”) is then manufactured as required and specific to the customer's needs by conventional grinding and polishing techniques.

A conventional apparatus for the injection-molding of plastic material spectacle lenses is described in EP 0 769 999 B1. In this prior art apparatus a conventional injection mold is used. The mold comprises two molding pieces for defining the molding cavity. The surfaces thereof facing each other correspond to the surfaces of the spectacle lens to be manufactured.

In this prior art apparatus, an individual adjustment is made possible because one of the molding pieces is adapted to be displaced along the optical axis of the lens relative to the other molding piece by means of a wedge positioning device. In such a way lenses of different thickness may be manufactured.

From WO 01/32407, mentioned at the outset, as well as from U.S. Pat. No. 5,547,618 and U.S. Pat. No. 5,662,839 it is known to manufacture fully finished spectacle lenses by plastic material molding instead of manufacturing just the above-mentioned semi-finished blanks. This is made possible by utilizing as a mold an assembly of two molding shells arranged at a distance relative to one another, wherein the molding shells are individually selected from an appropriate supply of such molds according to the specific spectacle lens to be manufactured. As it is thus possible to mold both spectacle lens surfaces specifically for a customer, it is no more necessary to work the prescription surface.

As already mentioned, this prior art approach, however, has the disadvantage that for each such apparatus a corresponding large supply of molding shells must be held in stock for both the front and the rear surface. For economical reasons the number of molding shells contained in such a stock is limited so that only a limited number of different spectacle lenses may be manufactured. Complicated lenses or highly individual lenses which are only rarely demanded in practice, may, therefore, not be manufactured in this way because a molding shell stock can only reflect the most common spectacle lens shapes.

The molding shell stock, moreover, is a substantial cost factor because substantial investment means are bound thereby.

Moreover, practice has shown that in this prior art approach with two molding shells an important problem lies in the shrinking of the plastic material. These shrinking processes are hard to control according to the actual state of the art or may even not be controlled at all. Accordingly, for making a specific spectacle lens it is often necessary to make several such lenses in an iterative approach, before, finally, a thermoset plastic material spectacle lens is at hand that has the desired optical characteristics.

Another disadvantage of this prior art approach lies in the fact that novel concepts of spectacle lens surfaces, in particular for individual progressive lenses may only be put into practice with a substantial delay in time and with corresponding costs because the entire supply of molding shells would have to be exchanged for that purpose.

It is, therefore, an object underlying the invention to further improve a process and an apparatus of the type specified at the outset such that the aforementioned disadvantages are avoided. In particular, the drawbacks of a large stock of molding shells shall be avoided, and it shall become possible to make highly specific lenses, in particular spectacle lenses, according to the demand of a customer, and to adapt existing concepts for spectacle lens surfaces to modern developments quickly and without substantial investments.

### SUMMARY OF THE INVENTION

In a method specified at the outset, this object is achieved in that at least one of the surfaces is deformed from an initial shape into the predetermined shape immediately prior to the bringing in of the plastic material and as a function of predetermined data.

In an apparatus of the type specified at the outset, this object is achieved in that means are provided for deforming at least one of the surfaces from an initial shape into the predetermined shape immediately prior to the bringing in of the plastic material as a function of predetermined data.

The object underlying the invention is thus entirely solved.

According to the invention, only one pair of molding shells is required which is used for molding lenses, in particular spectacle lenses, of any conceivable shape. This is achieved, according to the invention, in that the individual shape of the molding shells is set in the mold itself. The molding shells, therefore, typically stay within the mold and are individually set in their shape for each new molding process according to customer-specific values.

Therefore, no more costs have to be borne for stocking a supply of molding shells because by setting the corresponding data, the molding cavity is always defined for molding an individual lens with the same pair of molding shells. By doing so, a transition to a novel concept for spectacle lens surfaces may be effected by simply updating the software without the necessity of exchanging hardware.

The manufacturing process itself is thereby accelerated because as compared to the conventional mechanical exchange of molding shells, only a change in shape of the two molding shells must be effected which may be accomplished in a much shorter period of time.

Considering that the two molding shells may be deformed into practically any conceivable three-dimensional shape (within certain technical limits, of course), correspondingly arbitrary lenses may be made when the corresponding sets of data (spline surfaces) are fed to a process computer for controlling the apparatus of the present invention. Insofar the limitations with respect to the supply capacity or the product capacity as have been typical for conventional processes and apparatuses, are no more existing for the approach of the present invention.

For putting the individually set shaping of the molding shells into practice, techniques may be used as are known from the technology of astronomical telescopes under the catchword “adaptive optics”.

For example, DE 199 17 519 C2 and U.S. Pat. No. 4,280,756 describe different concepts for such large mirrors designed in “adaptive optics”.

These prior art concepts, as mentioned before, are related to large mirrors which may have diameters of several meters and for which weight problems play a major role. In order to be able to adjust such large mirrors in such a way, e.g. for astronomical purposes, for collecting sunlight in sunlight power plants and the like, it is well known to alter the focal point or the orientation of the optical axis of concave mirrors by making the reflecting surface thin and by providing same with a plurality of actuators for adapting the shape of such very large mirrors to the particular application.

A particular merit of the present invention, therefore, is to have transferred this concept, as known per se from the art of large mirrors, to the art of making plastic material spectacle lenses, which was not obvious at all for a skilled person, also considering that different arts are concerned where the dimensions differ by several orders of magnitude.

In preferred embodiments of the invention, the surface to be deformed is mechanically deformed, in particular by means of a plurality of mechanically operated positioning elements, for example fine threaded rods, fluidically operated actuators, etc.

As an alternative, one could also use electrically operated means based on a piezoelectric or a magnetostrictive effect.

A particularly good effect is achieved within the scope of the present invention when the deformation of the surface is sensed and the surface is deformed in a closed loop control circuit.

This measure has the advantage that in the course of the production of the lens, a high precision may be achieved because the surface as actually manufactured is not only set as a function of given parameters at the rim of the cavity but the setting is also monitored by a closed loop control and readjusted, as the case may be. In this context, one might also consider to compensate via the control loop for deviations in shape that may develop during the injection process by expansion or by shrinking.

Considering that it is quite difficult to measure the actual shape of the deformed surface itself, another embodiment of the invention provides that the deformation of the surface of the molding shell is sensed indirectly by simultaneously deforming the surface together with a reference surface and by sensing the deformation of the latter.

This measure has the advantage that the measuring operation is separated from the shaping molding shell so that the setup of the inventive apparatus as well as the carrying out of the inventive process are both facilitated.

Although one might consider to deform the reference surface on another scale as compared to the surface of the cavity itself and to adjust the different scales thereafter by mathematical operations, the invention prefers an embodiment in which the surface and the reference surface are deformed in the same manner.

In order to acquire the deformation of the surface or of the reference surface, resp., various known measuring methods may be used. In the context of the present invention it is particularly preferred to use a wave front sensor as for example described in DE 100 14 334 C2 to which reference is made for further details.

In the context of the present invention it is possible to make one molding shell rigid and to configure only the other molding shell deformable, preferably elastically, thereby going on from the conventional concept of the semi-products mentioned at the outset.

However, in the context of the present invention it is particularly preferred when the surfaces of both molding shells are deformed.

In order to do so, an apparatus is particularly preferred in which one micro manipulator each for deforming the molding shells is arranged on opposite sides of the molding shells, as viewed along the optical axis of the lens, wherein reference shells are arranged on the sides of the micro manipulators opposite the molding shells, the micro manipulators each deforming their associated molding shell and reference shell as a function of control signals from a control unit, and wave front sensors being arranged on the sides of the reference shells opposite the micro manipulators and being connected to the control unit.

With such an apparatus; all above-mentioned advantages may be obtained because a maximum flexibility in the shaping of the lenses in the shortest possible time of production at optimum precision in shape may be achieved.

Further advantages will become apparent from the description and the appended drawing.

It goes without saying that the features described above and those that will be explained hereinafter may not only be used in the particular given combination but also in other combinations or alone without leaving the scope of the present invention.

An embodiment of the invention is shown in the drawing and will be explained in further detail in the subsequent description.

### BRIEF DESCRIPTION OF THE DRAWING

The only FIGURE shows an extremely schematic side elevational view, partially in a cross-section, of an embodiment of an inventive apparatus as may be used for carrying out the inventive process.

### DETAILED DESCRIPTION OF THE PREFERRED EMBODIMENTS

In the FIGURE, reference numeral 10 as a whole indicates an apparatus for molding optical lenses, in particular for molding plastic material spectacle lenses.

Apparatus 10 is arranged along an axis 11 being also the optical axis of the lens to be molded.

A tube-shaped element 12 at its inner surface 13 receives a front molding shell 14 and a rear molding shell 16. Molding shells 14, 16 are arranged at an axial distance relative to one another. A gap 18 between them is defined by a convex surface 15 of front molding shell 14 and by a concave surface 17 of rear molding shell 16. In the illustrated embodiment, surfaces 15 and 17 are the optically determining surfaces of the lens to be made.

Via an opening 20, a fluid plastic material may be brought into gap 18, as indicated by an arrow 22.

The molding of the lenses as such is prior art and no part of the present invention.

In the illustrated embodiment, both molding shells 14 and 16 are configured deformable, in particular elastically deformable. As an alternative, only one molding shell may be made deformable and the other rigid, of course.

Further details of the invention shall now be explained with regard to rear molding shell 16.

As seen in an axial direction, a micro manipulator, indicated at 30, is arranged next to tube-shaped element 12. Micro manipulator 30 has a plurality of positioning elements 32 that can be displaced in an axial direction by means of positioning drives 33, as indicated by a double arrow 34.

The positioning elements may be fine threaded rods, however, pneumatically, piezoelectrically, magnetostrictively or otherwise displaceable actuators may likewise be used as positioning elements 32.

For the embodiment illustrated in the FIGURE, it is important that the positioning elements 32 extend beyond both sides of micro manipulator 30 and act like a through-rod. This means that when a positioning element 32 in the FIGURE is displaced e.g. to the right, the portion of positioning element 32 extending to the left is shortened, whereas the portion extending beyond the micro manipulator 30 to the right, is lengthened.

The FIGURE shows a side elevational view of micro manipulator 30. It goes without saying that positioning elements 32 in a view rotated by 900 are distributed over the entire surface of rear molding shell 16, i.e, over an at least essentially circular surface.

At their right hand terminal ends 36, positioning elements 32 engage contact- or attachment points 37 on a rear concave surface 38 of rear molding shell 16.

The opposite terminal end of positioning elements 32, being the left hand end in the FIGURE, in contrast engage a contact- or attachment point 39 of a convex surface 40 of a reference shell 42.

In this context, the term contact- or attachment point is to be understood to mean a point-shaped touching contact or an attachment, depending on whether only pushing forces or also pulling forces shall be transmitted from positioning elements 32 to molding shells 16, 42.

In the illustrated embodiment, reference shell 42 is configured similar to rear molding shell 16 and is held in an annular support 44.

A plane wave front sensor 46 is positioned on the side of reference shell 42 opposite micro manipulator 30. Light rays 48 are emitted from wave front sensor 46 onto a concave rear surface 50 of reference shell 42 and are again reflected from the latter. Wave front sensor 46 may be configured like e.g. the one disclosed in DE 100 14 334 C2. The details thereof are no part of the present invention.

The entire apparatus 10 is controlled by means of a control unit 52. Control unit 52 receives input signals via inputs 54, in particular spline functions of desired surfaces for the lens to be made.

Control unit 52 is connected to micro manipulator 30 via a control line 56, and receives measured signals from wave front sensor 46 via a control line 58.

The FIGURE further illustrates that front molding shell 14 may also be configured and arranged as described before. For such embodiments it is then correspondingly necessary to provide another micro manipulator 70 and another reference shell 72. For what concerns the positioning and the function thereof, reference is made to the foregoing and to the subsequent description.

Apparatus 10 operates as follows:

When a particular spectacle lens shall be made, the data of its surface or surfaces are transmitted as spline functions from a memory or otherwise to control unit 52. Control unit 52 activates micro manipulator 30 via control line 56. Within micro manipulator 30, positioning elements 32 are displaced by means of positioning drives 33 in an axial direction as a function of the entered data. As the opposite portions of positioning elements 32 alter their position reciprocally on opposite sides of micro manipulator 30, a true copy of concave surface 38 on the rear side of rear molding shell 16 is generated on convex surface 40 of reference shell 42. Given a constant thickness of reference shell 42, the shape of concave surface 50 on the rear side of reference shell 42 corresponds to the shape of concave surface 38 on the rear side of rear molding shell 16.

By means of wave front sensor 46, it is now examined whether the three-dimensional shape of concave surface 50 is in compliance with the given data. If this is not the case at individual points of surface 50, the corresponding positioning element 32 is adjusted accordingly via control unit 52 until the residual error is zero or is equal to a given minimum value within closed loop control 52-30-42-46.

When front molding shell 14 is configured rigid, the molding of the lens may now be initiated. In the other case, front molding shell 14 must likewise be brought into the predetermined shape by means of micro manipulator 70.

As soon as the cavity of apparatus 10 defined by gap 18 is set accordingly, the injection of the fluid or liquid plastic material through opening 20 may be started.

As soon as gap 18 is filled with fluid plastic material, the thermosetting thereof may be initiated. The thermosetting may be accelerated by irradiating UV light or by applying heat, as known per se. This is not a part of the present invention, nor is the loading and unloading of the molding shell or shells into and from the tube-shaped element 12, resp. It goes without saying that the tube-shaped element insofar is also to be understood only as an example and that other types of sealing may also be used for generating a closed cavity. Examples thereof may be found in WO 01/32407 mentioned at the outset.

To the extent as molding shells 14, 16 and reference shells 42, 72 must be deformable, they must be adapted to be moved within certain technical limits. For that purpose, they may be configured from glass or from metal of small thickness.

1. A process for molding optical lenses from a thermosettable plastic material, wherein two molding shells having surfaces of a predetermined shape are arranged at a distance relative to one another and are sealed at their periphery, said plastic material being brought into the gap enclosed by said surfaces between said molding shells, wherein at least one of said surfaces is deformed from an initial shape into said predetermined shape immediately prior to said bringing in of said plastic material and as a function of predetermined data.

2. The process of claim 1, wherein said surface is mechanically deformed.

3. The process of claim 2, wherein said surface is deformed by means of a plurality of mechanically operated positioning elements.

4. The process of claim 1, wherein said surface is deformed piezoelectrically.

5. The process of claim 1, wherein said surface is deformed magnetostrictively.

6. The process of claim 1, wherein said deformation of said surface is sensed and said surface is deformed in a closed loop control circuit.

7. The process of claim 6, wherein said deformation of said surface of said molding shell is sensed indirectly by simultaneously deforming said surface together with a reference surface and by sensing said deformation of the latter.

8. The process of claim 7, wherein said surface and said reference surface are deformed in the same manner.

9. The process of claims 6, wherein said deformation is sensed by means of a wave front sensor.

10. The process of claim 1, wherein said surfaces of both molding shells are deformed.

11. An apparatus for molding optical lenses from a thermosettable plastic material, comprising two molding shells arranged at a distance relative to one another, said molding shells having surfaces of a predetermined shape, and a sealing at said periphery of said molding shells, and means for bringing said plastic material into the gap enclosed by said surfaces between said molding shells, wherein means are provided for deforming at least one of said surfaces from an initial shape into said predetermined shape immediately prior to the bringing in of said plastic material as a function of predetermined data.

12. The apparatus of claim 11, wherein said deforming means are configured mechanically.

13. The apparatus of claim 12, wherein said deforming means comprise a plurality of mechanically operated positioning elements.

14. The apparatus of claim 13, wherein said positioning elements are part of a micro manipulator.

15. The apparatus of claim 13, wherein said positioning elements extend essentially parallel to said optical axis of said lens.

16. The apparatus of claim 11, wherein said deforming means are configured piezoelectrically.

17. The apparatus of claim 11, wherein said deforming means are configured magnetorestrictively.

18. The apparatus of claim 11, wherein means are provided for sensing said deformation of said surface, and a closed loop control circuit for deforming said surface.

19. The apparatus of claim 18, wherein a reference surface is provided, said means for deforming said surface of said molding shell simultaneously effecting a deformation of said reference surface, said means for sensing said deformation coacting with said reference surface.

20. The apparatus of claim 18, wherein said deformation sensing means are configured as a wave front sensor.

21. The apparatus of claim 11, wherein said molding shells (14, 16) are made from thin glass.

22. The apparatus of claim 11, wherein said molding shells are made from thin metal.

23. The apparatus of claim 19, wherein said reference surface is located on a reference shell and said reference shell is made from thin glass.

24. The apparatus of claim 19, wherein said reference surface is located on a reference shell and said reference shell is made from thin metal.

25. The apparatus of claim 11, wherein one micro manipulator each for deforming said molding shells is arranged on opposite sides of said molding shells, as viewed along said optical axis of said lens, reference shells being arranged on said sides of said micro manipulators opposite said molding shells, said micro manipulators each deforming their associated molding shell and reference shell as a function of control signals from a control unit, and wave front sensors being arranged on said sides of said reference shells opposite said micro manipulators and being connected to said control unit.

26. The apparatus of claim 11, wherein a first, deformable molding shell and a second, rigid molding shell are provided, a micro manipulator for deforming said first molding shell being arranged on one side of said first molding shell, as viewed along said optical axis of said lens, a reference shell being arranged on said side of said micro manipulator opposite said first molding shell, said micro manipulator deforming said first molding shell and said reference shell as a function of control signals from a control unit, and a wave front sensor being arranged on said side of said reference shell opposite said micro manipulator and being connected to said control unit.
